(19) United States
(12) Patent Application Publication
(10) Pub. No.: US 2015/0020098 A1
(43) Pub. Date: Jan. 15, 2015

(54) ELECTRONIC DEVICE SYSTEM

(71) Applicant: FUNAI ELECTRIC CO., LTD., Osaka (JP)

(72) Inventor: Masahiro MATSUDA, Osaka (JP)

(21) Appl. No.: 14/325,665

(22) Filed: Jul. 8, 2014

(30) Foreign Application Priority Data
Jul. 10, 2013 (JP) 2013-145009

(51) Int. Cl. H04N 21/422; H04N 21/47

(52) U.S. Cl. CPC H04N 21/42206; H04N 21/47
USPC 725/37

(57) ABSTRACT

An electronic device system includes: a set-top box which causes a display unit to display an image; and a remote control which is capable of bidirectionally communicating with the set-top box, for remotely operating the set-top box, wherein the remote control includes: a gyro sensor which detects a motion of the remote control; and a power supply unit switchable between (i) a normal mode in which power is supplied to the gyro sensor and (ii) a power save mode in which power supply to the gyro sensor is stopped, the set-top box transmits a first signal to the remote control, when determining that a first condition is satisfied for the set-top box, and the power supply unit of the remote control is switched from the normal mode to the power save mode, according to the first signal from the set-top box.

### CROSS REFERENCE TO RELATED APPLICATION

The present application is based on and claims priority of Japanese Patent Application No. 2013-145009 filed on Jul. 10, 2013. The entire disclosure of the above-identified application, including the specification, drawings and claims is incorporated herein by reference in its entirety.

### FIELD

The present invention relates to an electronic device system including an electronic device and a remote control for remotely operating the electronic device.

### BACKGROUND

Recent years have seen a set-top box (STB) (included in the electronic device) which enables use of the Internet with a television receiver. The set-top box is connectable to the Internet via a wireless local area network (LAN). With the set-top box connected to the television receiver, it is possible to display on a display panel of the television receiver, for example, a website or the like on the Internet.

The above-described set-top box can be remotely operated using a remote control as a pointing device (for example, see patent literature (PTL)). The remote control includes a gyro sensor which measures an angular velocity of the remote control. An angular velocity signal from the gyro sensor is transmitted to the set-top box from the remote control. With this, for example, when a user moves a remote control held in a hand, a pointer displayed on the display panel can be moved according to the movement of the remote control.

A conventional remote control has a power saving function to achieve power-saving of the remote control. The power saving function is a function performed by the remote control to switch the remote control from a normal mode to a power save mode. The normal mode is a mode in which power is supplied from a battery included in the remote control to a gyro sensor. On the other hand, the power save mode is a mode in which the power supplied from the battery, which is included in the remote control, to the gyro sensor is stopped. For example, the remote control switches the remote control from the normal mode to the power save mode, when the remote control is not operated for a predetermined period (e.g., 5 minutes).

### CITATION LIST

### Patent Literature

[PTL] Japanese Unexamined Patent Application Publication No. 2010-79824

### SUMMARY

### Technical Problem

However, with a configuration in which a remote control switches between a normal mode and a power save mode according to a state of the remote control as described above, there may be a case in which power saving of the remote control cannot be sufficiently achieved. More specifically, for example, there is a case in which a user connects another operation device (e.g., a mouse or the like) to a set-top box, and operates the set-top box using the operation device. In this case, the remote control is kept in the normal mode until a predetermined period passes from the time when the operation device is connected to the set-top box. Thus, power is continuously supplied to the gyro sensor in the above-described period during which the user do not operate the remote control. Consequently, the battery included in the remote control drains relatively quickly.

The present invention aims at solving the above-described problem, and has as an object to provide an electronic device system which can sufficiently achieve power saving of the remote control.

### Solution to Problem

In order to achieve the above object, an electronic device system according to an aspect of the present invention includes: an electronic device which causes a display unit to display an image; and a remote control which is capable of bidirectionally communicating with the electronic device, for remotely operating the electronic device, wherein the remote control includes: a sensor which detects a motion of the remote control; a power supply unit switchable between (i) a normal mode in which power is supplied to the sensor and (ii) a power save mode in which power supply to the sensor is stopped; and a communication unit configured to transmit, based on the motion of the remote control detected by the sensor, a remote control signal for remotely operating the electronic device, the electronic device transmits a first signal to the remote control, when determining that a first condition is satisfied for the electronic device, and the power supply unit of the remote control is switched from the normal mode to the power save mode, according to the first signal from the electronic device.

According to this aspect, the electronic device transmits the first signal to the remote control, when determining that the first condition is satisfied for the electronic device. With this, the power supply unit of the remote control can be switched from the normal mode to the power save mode, when the state of electronic device is changed to a state in which the user is assumed not to operate the remote control. This makes it possible to reduce the power supplied from the power supply unit to the sensor during the period in which the user does not operate the remote control, effectively reducing the amount of power consumed by the power supply unit.

For example, in the electronic device system according to an aspect of the present invention, the electronic device may further transmit the second signal to the remote control, when determining that a second condition is satisfied for the electronic device after transmitting the first signal to the remote control, and the power supply unit of the remote control may be switched from the power save mode to the normal mode, according to the second signal from the electronic device.

According to this aspect, the electronic device further transmits a second signal to the remote control, when determining that the second condition is satisfied for the electronic device after transmitting the first signal to the remote control. With this, when the state of the electronic device is changed to the state in which the user is assumed to operate the remote control again, the power supply unit of the remote control can be switched from the power save mode to the normal mode. As a result, the user can smoothly resume the operation of the remote control.

For example, in the electronic device system according to an aspect of the present invention, the electronic device may include an application which is for reproducing content, and the electronic device may determine that the first condition is satisfied for the electronic device, when an operation of the remote control for changing a reproduction state of the content is not performed for a predetermined period while the application reproduces the content.

According to this aspect, it is assumed that the user is viewing content and thus does not operate the remote control, when an operation of the remote control for changing a reproduction state of the content is not performed for the predetermined period while the application reproduces the content. Thus, in this case, the electronic device can determine that the state of the electronic device is changed to a state in which the user is assumed not to operate the remote control.

For example, in the electronic device system according to an aspect of the present invention, the electronic device may determine that the second condition is satisfied for the electronic device, when the application ends reproduction of the content after the electronic device transmits the first signal to the remote control.

According to this aspect, it is assumed that the user finished viewing the content and thus operates the remote control again, when the application ends the reproduction of the content. Thus, in this case, the electronic device can determine that the state of the electronic device is changed to the state in which the user is assumed to operate the remote control again.

For example, in the electronic device system according to an aspect of the present invention, the electronic device may be connectable with an operation device which is for operating the electronic device, and the electronic device may determine that the first condition is satisfied for the electronic device, when the operation device is connected to the electronic device.

According to this aspect, when an operation device different from the remote control is connected to the electronic device, it is assumed that the user operates the electronic device using the operation device and thus does not operate the remote control to operate the electronic device. Thus, in this case, the electronic device can determine that the state of the electronic device is changed to the state in which the user is assumed not to operate the remote control.

For example, in the electronic device system according to an aspect of the present invention, the electronic device may determine that the second condition is satisfied for the electronic device, when the operation device and the electronic device are disconnected after the electronic device transmits the first signal to the remote control.

According to this aspect, it is assumed that the user operates the remote control again, when the operation device and the electronic device are disconnected. Thus, in this case, the electronic device can determine that the state of the electronic device is changed to a state in which the user is assumed to operate the remote control again.

For example, in the electronic device system according to an aspect of the present invention, the electronic device may determine that the first condition is satisfied for the electronic device, when the electronic device is not remotely operated using the remote control for a predetermined period.

According to this aspect, when the electronic device is not remotely operated using the remote control for a predetermined period, it is assumed that the user does not need to operate the electronic device and thus does not operate the remote control. Thus, in this case, the electronic device can determine that the state of the electronic device is changed to a state in which the user is assumed not to operate the remote control.

For example, in the electronic device system according to an aspect of the present invention, the power supply unit of the remote control may be switched from the power save mode to the normal mode, when the remote control is operated after the remote control receives the first signal from the electronic device.

According to this aspect, it is possible to switch the power supply unit of the remote control from the power save mode to the normal mode, when the user operates the remote control again.

For example, in the electronic device system according to an aspect of the present invention, the electronic device may determine that the first condition is satisfied for the electronic device, when a menu screen is not displayed as an on-screen display (OSD) on the display unit for a predetermined period.

According to this aspect, when the menu screen is not displayed as the OSD on the display unit for the predetermined period, it is assumed that the user does not need to operate the electronic device and thus does not operate the remote control. Thus, in this case, the electronic device can determine that the state of the electronic device is changed to a state in which the user is assumed not to operate the remote control.

For example, in the electronic device system according to an aspect of the present invention, the electronic device may determine that the second condition is satisfied for the electronic device, when the menu screen is displayed as the OSD on the display unit after the electronic device transmits the first signal to the remote control.

According to this aspect, when the menu screen is displayed on the display unit as the OSD again, it is assumed that the user needs to operate the electronic device and thus operates the remote control again. Thus, in this case, the electronic device can determine that the state of the electronic device is changed to a state in which the user is assumed to operate the remote control again.

For example, in the electronic device system according to an aspect of the present invention, the sensor may be a gyro sensor or an acceleration sensor.

According to this aspect, the sensor can include the gyro sensor or the acceleration sensor.

For example, in the electronic device system according to an aspect of the present invention, the display unit may be provided on a television receiver, and the electronic device may be a set-top box connected to the television receiver.

According to this aspect, the electronic device can include the set-top box connected to the television receiver.

Note that, the present invention can be realized not only as an electronic device system including such a characteristic control unit but also as a control method including steps of processing executed by such a characteristic control unit included in the electronic device system. The present invention can also be realized as a program which causes a computer to function as the characteristic control unit included in the electronic device system, or a program which causes a computer to execute the characteristic steps included in the control method. In addition, it goes without saying that such a program can be distributed via a non-transitory computer-readable recording medium, such as a CD-ROM (Compact Disc-Read Only Memory) or a communication network, such as the Internet.

### Advantageous Effects

With an electronic device system according to an aspect of the present invention, a power supply unit of a remote control is switched between a normal mode and a power save mode according to a state of an electronic device to achieve sufficient power saving of a remote control.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a diagram showing a configuration of an electronic device system according to Embodiment 1.

FIG. 2 is a block diagram showing a functional configuration of a set-top box according to Embodiment 1.

FIG. 3 is a block diagram showing a functional configuration of a remote control according to Embodiment 1.

FIG. 4 is a sequence diagram showing a flow of switching between a normal mode and a power save mode in the electronic device system according to Embodiment 1.

FIG. 5 is a diagram showing a state where a menu screen of an application is displayed as an OSD on a display panel.

FIG. 6 is a sequence diagram showing a flow of switching between a normal mode and a power save mode in an electronic device system according to Embodiment 2.

FIG. 7 is a sequence diagram showing a flow of switching between a normal mode and a power save mode in an electronic device system according to Embodiment 3.

FIG. 8 is a sequence diagram showing a flow of switching between a normal mode and a power save mode in an electronic device system according to Embodiment 4.

### DESCRIPTION OF EMBODIMENTS

The following describes embodiments according to the present invention in detail with reference to drawings. It should be noted that the embodiments described hereafter illustrate preferred specific examples of the present invention. Numerical values, shapes, materials, structural elements, the positioning and connection configuration of the structural elements, steps, the sequence of the steps, and so on, described in the embodiments below are merely examples and are not intended to limit the present invention. The present invention is defined by the Claims. Therefore, among the structural elements in the following embodiments, those structural elements which are not described in the independent claims of the present invention are not necessarily required in order to achieve an object of the present invention but are described as elements for configuring a more preferable embodiment.

### Embodiment 1

### Configuration Outline of Electronic Device System

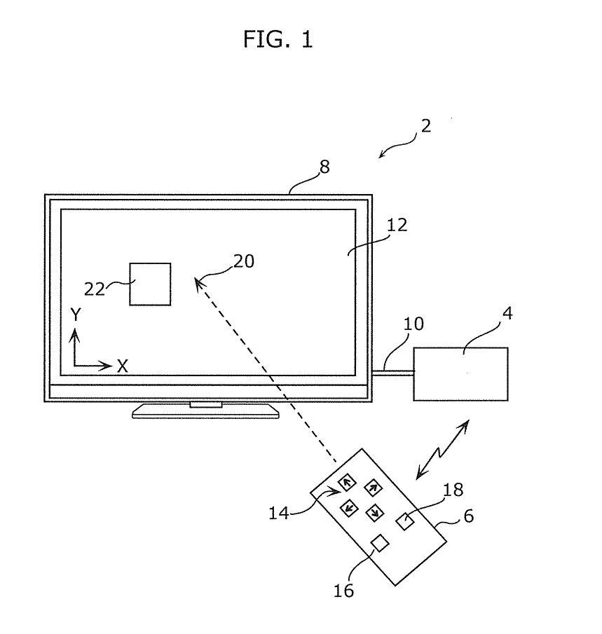

First, a configuration outline of an electronic device system according to Embodiment 1 is described with reference to FIG. 1. FIG. 1 is a diagram showing a configuration of the electronic device system according to Embodiment 1.

As shown in FIG. 1, the electronic device system 2 according to this embodiment includes a set-top box 4 and a remote control 6. It should be noted that the “set-top box” is indicated as “STB” in the drawings.

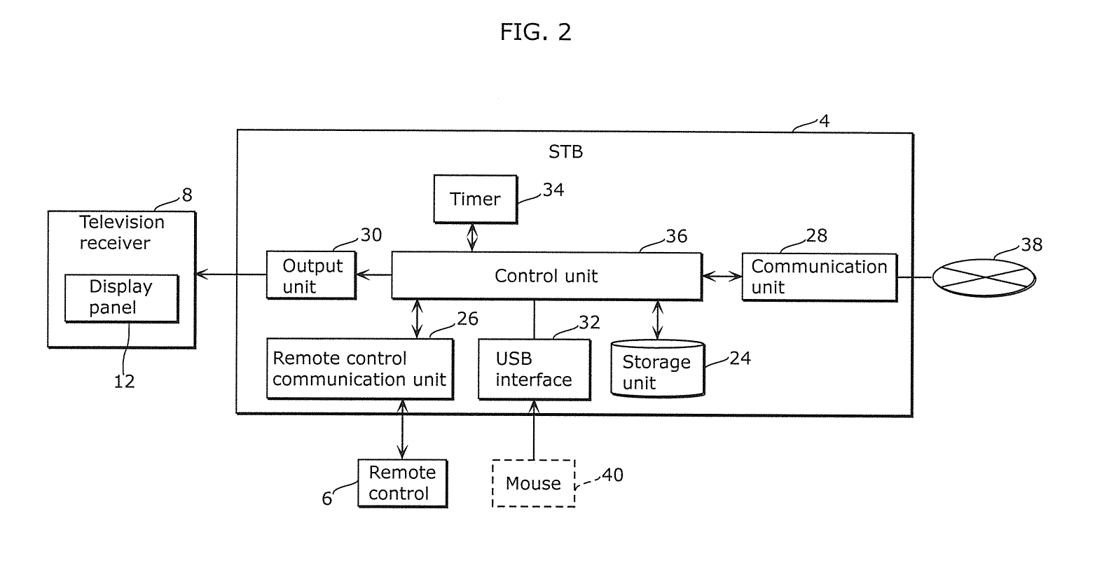

The set-top box 4 is an electronic device which enables use of the Internet and use of an application with a television receiver 8. The set-top box 4 is connected to the television receiver 8 via a high-definition multimedia interface (HDMI) cable 10 (HDMI is a registered trademark). Note that, the television receiver 8 includes a display panel 12 (included in a display unit) for displaying an image. Furthermore, the set-top box 4 is connected to the Internet 38 (see FIG. 2 which will be described later) via a wireless LAN (not illustrated). Furthermore, the set-top box 4 includes various applications. Note that, the applications are applications which operate on an operating system (OS), such as Android (Android is a registered trademark) for example.

The remote control 6 is a pointing device which is for remotely operating the set-top box 4. The remote control 6 includes, for example, arrow keys 14, a determination key 16, a mode switch key 18, and the like.

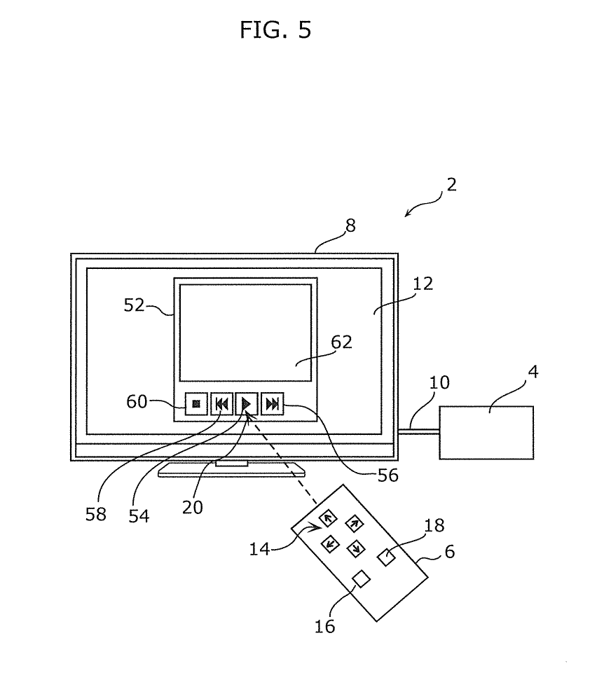

Each of the arrow keys 14 and the determination key 16 is a key for operating a menu screen 52 (see FIG. 5 which will be described later) or the like which is displayed as an on-screen display (OSD) on the display panel 12, for example.

The mode switch key 18 is a key for switching between a cursor mode and a pointing mode. Pressing the mode switch key 18 enables switching from the cursor mode to the pointing mode (or from the pointing mode to the cursor mode). The cursor mode is a mode in which a cursor (not illustrated) displayed on the display panel 12 is moved with an operation of the arrow keys 14. The pointing mode is a mode in which a user moves the remote control 6 held in a hand in an up-down or right-left direction to move a pointer 20 displayed on the display panel 12 according to a movement of the remote control 6. Note that, the pointer 20 is not displayed on the display panel 12 in the cursor mode.

Remote operation of the set-top box 4 using the remote control 6 is performed as follows. For example, in the case where an application is to be activated in the pointing mode when an icon 22 for activating the application is displayed on the display panel 12, first, a user presses the mode switch key 18 to switch from the cursor mode to the pointing mode. Next, the user places the pointer 20 on the icon 22 by moving the remote control 6 held in a hand in an up-down or right-left direction. Then, the user presses the determination key 16. With this, for example, an application for reproducing content (a video, music, an image, and the like) is activated, and the reproduced content is displayed on the display panel 12.

### [Functional Configuration of Set-Top Box]

Next, a functional configuration of the above-described set-top box 4 is described with reference to FIG. 2. FIG. 2 is a block diagram showing a functional configuration of a set-top box according to Embodiment 1.

As shown in FIG. 2, the set-top box 4 includes: a storage unit 24, a remote control communication unit 26, a communication unit 28, an output unit 30, a universal serial bus (USB) interface 32, a timer 34, and a control unit 36.

The storage unit 24 is a read only memory (ROM) storing a control program, various applications, and the like. An example of the applications stored in the storage unit 24 is an application for reproducing content, or the like.

The remote control communication unit 26 is an interface for performing bidirectional communication with the remote control 6 using, for example, Bluetooth (Bluetooth is a registered trademark). The remote control communication unit 26 receives a remote control signal (a signal including angular velocity information and key input information which will be described later) output from the remote control 6. The remote control communication unit 26 converts the received remote control signal into the remote control code, and outputs the remote control code to the control unit 36. Furthermore, the remote control communication unit 26 transmits, to the remote control 6, a first signal or a second signal (which will be described later) output from the control unit 36.

The communication unit 28 is an interface for mutually connecting the set-top box 4 and the Internet 38 via a wireless LAN (not illustrated).

The output unit 30 is an interface for mutually connecting the set-top box 4 and the television receiver 8 via an HDMI (HDMI is a registered trademark) cable 10.

The USB interface 32 is a communication adapter for mutually connecting the set-top box 4 and a USB device. The USB interface 32 is connected with, as the USB device, an operation device (e.g., a mouse 40, a keyboard, and the like) for operating the set-top box 4, for example.

The timer 34 counts elapsed time from when the application stored in the storage unit 24 starts reproducing content. Note that, the elapsed time counted by the timer 34 is reset when the remote control information (the key input information which will be described later) is transmitted to the set-top box 4 from the remote control 6. In this case, the timer 34 counts elapsed time again from when the remote control information (the key input information which will be described later) is transmitted to the set-top box 4 from the remote control 6.

The control unit 36 includes, for example, a microcomputer. The control unit 36 performs comprehensive control on the set-top box 4 based on a control program stored in the storage unit 24. The following describes various functions of the control unit 36.

The control unit 36 controls content displayed on the display panel 12 of the television receiver 8. The control unit 36 causes a website on the Internet 38 or content reproduced by an application to be displayed on the display panel 12. Furthermore, the control unit 36 causes the display panel 12 to display, as the OSD, the menu screen 52 or the like of an application, for example.

Furthermore, the control unit 36 performs, according to the remote control code output from the remote control communication unit 26, various controls (e.g., switching between the cursor mode and the pointing mode, movement of the pointer 20, activation of an application, and the like).

Furthermore, the control unit 36 causes the display panel 12 to display the pointer 20 in the above-described pointing mode, and moves a display position of the pointer 20 on the display panel 12. More specifically, the control unit 36 sets, according to the remote control signal (angular velocity information which will be described later) from the remote control 6, a display position (e.g., XY coordinates) of the pointer 20 accordingly. For example, when the angular velocity information includes a rate of acceleration in an X-axis direction (i.e., a horizontal direction of the display panel 12), the control unit 36 moves the display position of the pointer 20 in the X-axis direction by a distance corresponding to a magnitude of the rate of acceleration. When the angular velocity information includes a rate of acceleration in a Y-axis direction (i.e., a vertical direction of the display panel 12), the control unit 36 moves the display position of the pointer 20 in the Y-axis direction by a distance corresponding to a magnitude of the rate of acceleration. Specifically, the user can move the display position of the pointer 20 by changing an angle of the remote control 6 with respect to the display panel 12.

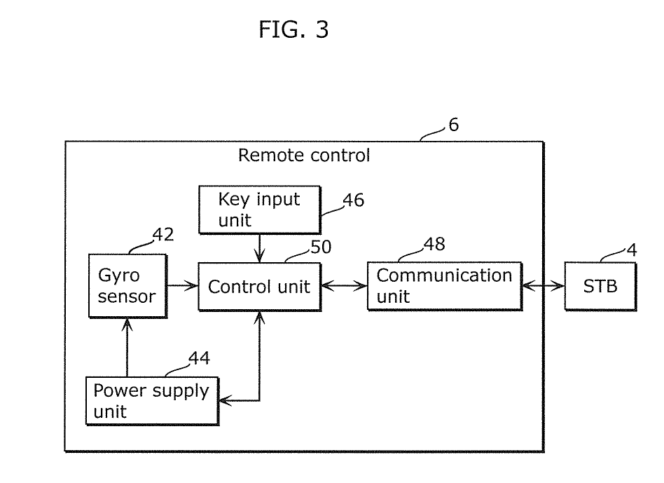

Here, characteristic functions of the control unit 36 are described. The control unit 36 transmits the first signal or the second signal to the remote control 6 via the remote control communication unit 26. The first signal is a signal for instructing a control unit 50 (see FIG. 3 which will be described later) of the remote control 6 to stop supply of power to a gyro sensor 42 (see FIG. 3 which will be described later) provided in the remote control 6. The second signal is a signal for instructing the control unit 50 of the remote control 6 to resume the supply of power to the gyro sensor 42.

The control unit 36 transmits the first signal to the remote control 6, when determining that an operation of the remote control 6 for changing reproduction state of content is not performed for a predetermined period (e.g., several seconds to less than 20 seconds) while the application reproduces the content (i.e., a first condition is satisfied for the set-top box 4). The control unit 36 determines, based on the elapsed time counted by the timer 34, whether or not an operation of the remote control 6 for changing the reproduction state of content is not performed for the above-described predetermined period while the application reproduces the content (stated differently, whether or not the key input information which will be described later is not transmitted to the set-top box 4 from the remote control 6 for the predetermined period). Note that, the “operation of the remote control 6 for changing the reproduction state of content” is, for example, an operation which stops the reproduction of content, an operation which suspends the reproduction of content, an operation which skips the reproduction of content, or the like.

The control unit 36 further transmits the second signal to the remote control 6, when determining that the application ends the reproduction of content after transmitting the first signal to the remote control 6 (i.e., a second condition is satisfied for the set-top box 4).

### [Functional Configuration of Remote Control]

Next, a functional configuration of the above-described remote control 6 is described with reference to FIG. 3. FIG. 3 is a block diagram showing a functional configuration of the remote control according to Embodiment 1.

As shown in FIG. 3, the remote control 6 includes, the gyro sensor 42 (which is included in a sensor), a power supply unit 44, a key input unit 46, a communication unit 48, and the control unit 50.

The gyro sensor 42 is included in the remote control 6, and is a sensor which measures an angular velocity of the remote control 6 (i.e., detects a motion of the remote control 6). More specifically, the gyro sensor 42 measures, as an angular velocity, each of (i) the rate of acceleration of the remote control 6 in the X-axis direction (see FIG. 1) and (ii) the rate of acceleration of the remote control 6 in the Y-axis direction (see FIG. 1). The gyro sensor 42 outputs, to the control unit 50, the angular velocity information indicating the measured angular velocity.

The power supply unit 44 is included in the remote control 6, and is a dry battery or a rechargeable battery which is for supplying power to the gyro sensor 42, the control unit 50, and the like. The power supply unit 44 is switched between the normal mode and the power save mode according to an instruction from the control unit 50. The normal mode is a mode in which the power from the power supply unit 44 is supplied to the gyro sensor 42. The power save mode is a mode in which the supply of the power from the power supply unit 44 to the gyro sensor 42 is stopped. The timing for switching between the normal mode and the power save mode will be described later.

The key input unit 46 detects a pressed key on the remote control 6 (e.g., the arrow keys 14, the determination key 16, the mode switch key 18, and the like), and generates the key input information indicating which key is pressed. The key input unit 46 outputs the generated key input information to the control unit 50.

The communication unit 48 is an interface which is for performing bidirectional wireless communication with the set-top box 4, for example, using Bluetooth (Bluetooth is a registered trademark) or the like. The communication unit 48 transmits, as a remote control signal, each of the angular velocity information and the key input information output from the control unit 50 to the set-top box 4. Specifically, the communication unit 48 transmits the angular velocity information to the set-top box 4, when the user moves the remote control 6 held in a hand. On the other hand, the communication unit 48 transmits the key input information to the set-top box 4, when the user presses a key on the remote control 6 (e.g., the arrow keys 14, the determination key 16, the mode switch key 18, and the like). Furthermore, the communication unit 48 receives the first signal or the second signal transmitted from the set-top box 4.

The control unit 50 outputs each of the angular velocity information from the gyro sensor 42 and the key input information from the key input unit 46 to the communication unit 48.

Here, characteristic functions of the control unit 50 are described. The control unit 50 switches the power supply unit 44 from the normal mode to the power save mode, when receiving the first signal from the set-top box 4. On the other hand, the control unit 50 switches the power supply unit 44 from the power save mode to the normal mode, when receiving the second signal from the set-top box 4.

### [Flow of Switching Between Normal Mode and Power Save Mode]

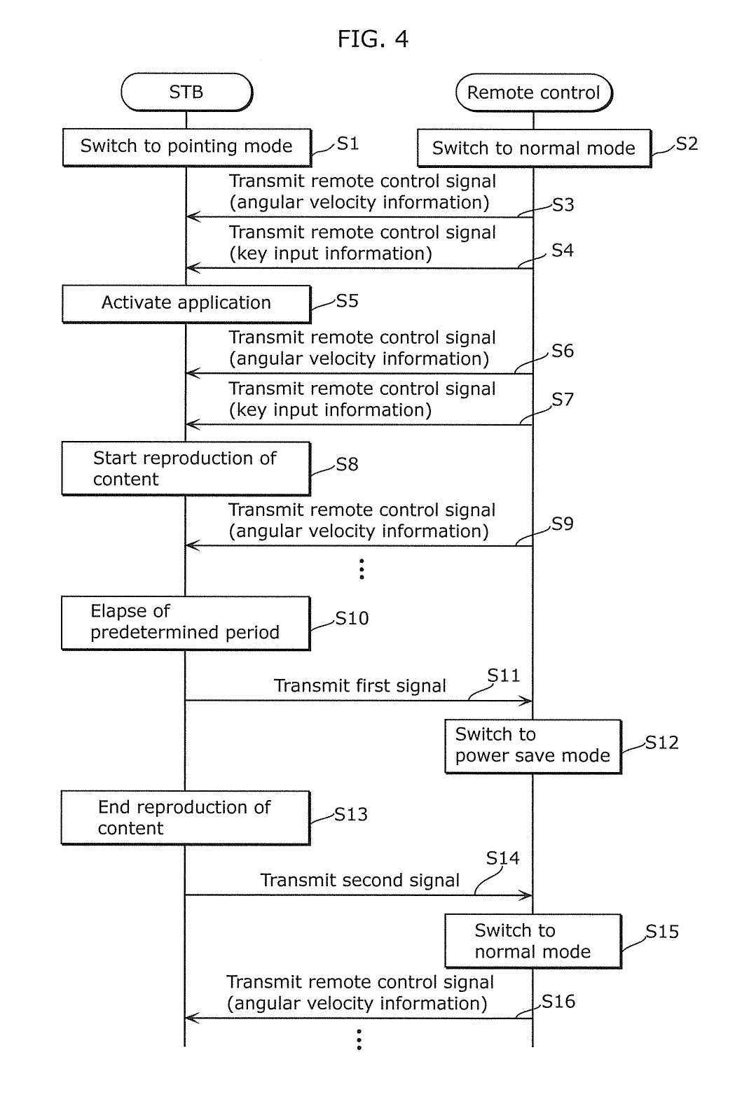

Next, a flow of switching between the normal mode and the power save mode which is a characteristic function of the electronic device system 2 according to this embodiment is described with reference to FIG. 4 and FIG. 5. FIG. 4 is a sequence diagram showing a flow of switching between the normal mode and the power save mode in the electronic device system according to Embodiment 1. FIG. 5 is a diagram showing a state in which a menu screen of an application is displayed as an OSD on the display panel.

As shown in FIG. 4, the set-top box 4 is switched to the pointing mode (S1) by the user pressing the mode switch key 18 on the remote control 6. With this, the pointer 20 is displayed on the display panel 12. Furthermore, the power supply unit 44 of the remote control 6 is switched to the normal mode (S2). With this, the power from the power supply unit 44 is supplied to the gyro sensor 42.

In this state, the user activates an application for reproducing content (e.g., a video obtained from the Internet 38) by operating the remote control 6. First, the user places the pointer 20 on the icon 22 (see FIG. 1) on the display panel 12 by moving the remote control 6 held in a hand in an up-down or right-left direction. At this time, the remote control 6 transmits the remote control signal (the angular velocity information) to the set-top box 4 (S3). Then, the user uses presses the determination key 16 on the remote control 6. With this, the remote control 6 transmits the remote control signal (the key input information) to the set-top box 4 (S4), activating the application (S5).

As shown in FIG. 5, when the application is activated, the menu screen 52 of the application is displayed as the OSD on the display panel 12. In the menu screen 52, for example, a reproduction button 54 for starting reproduction of content, skip buttons 56 and 58 for skipping reproduction of content, a stop button 60 for stopping reproduction of content, and the like are arranged.

When starting the reproduction of content, first, the user places the pointer 20 on the reproduction button 54 on the display panel 12 by moving the remote control 6 held in a hand in an up-down or right-left direction. At this time, the remote control 6 transmits the remote control signal (the angular velocity information) to the set-top box 4 (S6). Then, the user presses the determination key 16 on the remote control 6. With this, the remote control 6 transmits the remote control signal (the key input information) to the set-top box 4 (S7), starting the reproduction of content (S8). Note that, in a display area 62 in the menu screen 52, the reproduced content is displayed.

When the user moves the remote control 6 held in a hand in an up-down or right-left direction after the reproduction of the content is started, the remote control 6 transmits the remote control signal (the angular velocity information) to the set-top box 4 (S9), and the display position of the pointer 20 moves.

When an operation of the remote control 6 for changing the reproduction state of content is not performed for a predetermined period (e.g., several seconds to less than 20 seconds) while the application reproduces the content (S10), the set-top box 4 transmits the first signal to the remote control 6 (S11). The power supply unit 44 of the remote control 6 is switched from the normal mode to the power save mode according to the first signal from the set-top box 4 (S12). With this, the supply of power from the power supply unit 44 to the gyro sensor 42 is stopped. Thereafter, the gyro sensor 42 does not measure angular velocity of the remote control 6. Thus, the remote control 6 does not transmit the remote control signal (the angular velocity information) to the set-top box 4 even when the user moves the remote control 6 held in a hand in an up-down or right-left direction. Thus, the display position of the pointer 20 on the display panel 12 does not move even when the user moves the remote control 6 held in a hand in an up-down or right-left direction.

Note that, the control unit 36 of the set-top box 4 can also perform control to cause the display panel 12 to avoid displaying the pointer 20 when transmitting the first signal to the remote control 6. Alternatively, the control unit 36 of the set-top box 4 can perform control to achieve automatic switching from the pointing mode to the cursor mode when transmitting the first signal to the remote control 6.

After this, when the application ends the reproduction of the content (S13), the set-top box 4 transmits the second signal to the remote control 6 (S14). The power supply unit 44 of the remote control 6 switches from the power save mode to the normal mode again according to the second signal from the set-top box 4 (S15). With this, the supply of power from the power supply unit 44 to the gyro sensor 42 is resumed. Thereafter, the gyro sensor 42 measures the angular velocity of the remote control 6 again. Thus, the remote control 6 transmits the remote control signal (the angular velocity information) to the set-top box 4, when the user moves the remote control 6 held in a hand in an up-down or right-left direction (S16).

Note that, the control unit 36 of the set-top box 4 can also perform control to cause the display panel 12 to display the pointer 20, when the control unit 36 transmits the second signal to the remote control 6.

### [Advantageous Effects]

Next, advantageous effects produced by the electronic device system 2 according to this embodiment are described. As described above, when an operation of the remote control 6 for changing the reproduction state of content is not performed for a predetermined period while the application reproduces the content, it is assumed that the user is viewing the content and thus does not operate the remote control 6. Thus, with the set-top box 4 transmitting the first signal to the remote control 6 at this point, it is possible to reduce the power supplied from the power supply unit 44 to the gyro sensor 42 in a period in which the user does not operate the remote control 6. This makes it possible to effectively reduce the amount of power consumed by the power supply unit 44 of the remote control 6.

Thus, in the electronic device system 2 according to this embodiment, the power supply unit 44 of the remote control 6 is switched from the normal mode to the power save mode according to the state of the set-top box 4. Thus, power saving of the remote control 6 can be sufficiently achieved.

Furthermore, when the application ends the reproduction of content, the user is assumed to operate the remote control 6 again because the user finished viewing the content. Thus, with the set-top box 4 transmitting the second signal to the remote control 6 at this point, the user can smoothly resume the operation of the remote control 6.

### Embodiment 2

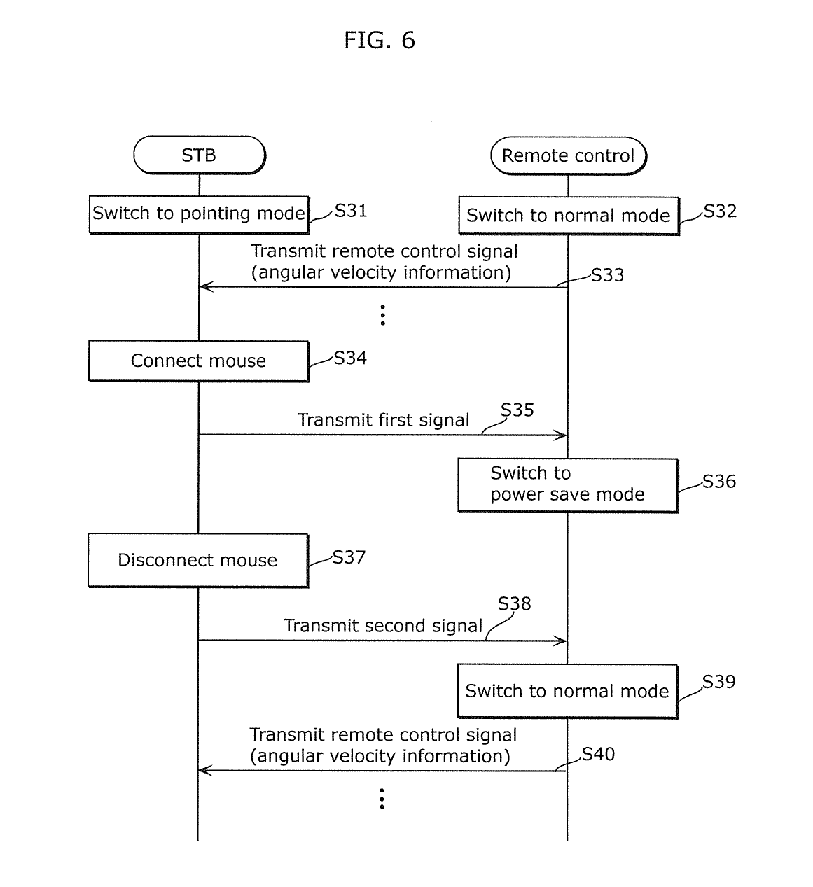

Next, a configuration of an electronic device system according to Embodiment 2 is described with reference to FIG. 6. FIG. 6 is a sequence diagram showing a flow of switching between a normal mode and a power save mode in the electronic device system according to Embodiment 2. Note that, in each of embodiments described below, structural elements same as the structural elements in the above-described Embodiment 1 are denoted with identical reference numerals, and descriptions thereof are omitted.

An electronic device system 2 according to this embodiment has a similar functional configuration as an electronic device system according to the above-described Embodiment 1. Thus, a functional configuration of each of a set-top box 4 and a remote control 6 is described with reference to FIG. 1 to FIG. 3.

In the electronic device system 2 according to this embodiment, a control unit 36 of the set-top box 4 transmits a first signal to the remote control 6, when determining that a USB device (in this embodiment, a mouse 40) is connected to the set-top box 4 (i.e., a first condition is satisfied for the set-top box 4). The control unit 36 further transmits a second signal to the remote control 6, when determining that the set-top box 4 and the USB device are disconnected after the control unit 36 transmits the first signal to the remote control 6 (i.e., a second condition is satisfied for the set-top box 4).

Note that, the “USB device is connected to the set-top box 4” means not only the USB device physically connected to a USB interface 32 but also means the USB device virtually connected to the control unit 36. Furthermore, “the set-top box 4 and the USB device are disconnected” means not only the USB device physically disconnected from the USB interface 32, but also means the USB device virtually disconnected from the set-top box 4.

Next, a flow of switching between the normal mode and the power save mode in the electronic device system 2 according to this embodiment is described with reference to FIG. 6. As shown in FIG. 6, the set-top box 4 is switched to the pointing mode (S31) by the user pressing a mode switch key 18 on the remote control 6. Furthermore, a power supply unit 44 of the remote control 6 is switched to the normal mode (S32).

In this state, when the user moves the remote control 6 held in a hand in an up-down or right-left direction, the remote control 6 transmits the remote control signal (angular velocity information) to the set-top box 4 (S33). After this, when the user connects the mouse 40 to the USB interface 32 of the set-top box 4 to operate the set-top using the mouse 40 (S34), the set-top box 4 transmits the first signal to the remote control 6 (S35). The power supply unit 44 of the remote control 6 is switched from the normal mode to the power save mode according to the first signal from the set-top box 4 (S36). With this, supply of power from the power supply unit 44 to a gyro sensor 42 is stopped.

After this, when the user disconnects the mouse 40 from the USB interface 32 (S37), the set-top box 4 transmits the second signal to the remote control 6 (S38). The power supply unit 44 of the remote control 6 is switched from the power save mode to the normal mode again, according to the second signal from the set-top box 4 (S39). With this, the supply of power from the power supply unit 44 to the gyro sensor 42 is resumed. Thereafter, the gyro sensor 42 measures the angular velocity of the remote control 6 again. Thus, the remote control 6 transmits the remote control signal (the angular velocity information) to the set-top box 4, when the user moves the remote control 6 held in a hand in an up-down or right-left direction (S40).

Next, advantageous effects produced by the electronic device system 2 according to this embodiment are described. As described above, when the user connects the mouse 40 to the USB interface 32 of the set-top box 4, it is assumed that the user operates the set-top box 4 using the mouse 40, and thus does not operate the remote control 6. Thus, with the set-top box 4 transmitting the first signal to the remote control 6 at this point, it is possible to reduce the power supplied from the power supply unit 44 to the gyro sensor 42 in a period in which the user does not operate the remote control 6. This makes it possible to effectively reduce the amount of power consumed by the power supply unit 44 of the remote control 6.

Furthermore, when the user disconnects the mouse 40 from the USB interface 32, the user is assumed to operate the remote control 6 again. Thus, with the set-top box 4 transmitting the second signal to the remote control 6 at this point, the user can smoothly resume the operation of the remote control 6.

Note that, the control unit 36 of the set-top box 4 transmits the first signal to the remote control 6, when determining that the USB device is connected to the set-top box 4 in this embodiment. Alternatively, the control unit 36 may transmit the first signal to the remote control 6, when determining that a smartphone, a tablet device, or the like (included in an operation device) in which a remote control application is activated is connected to the set-top box 4.

### Embodiment 3

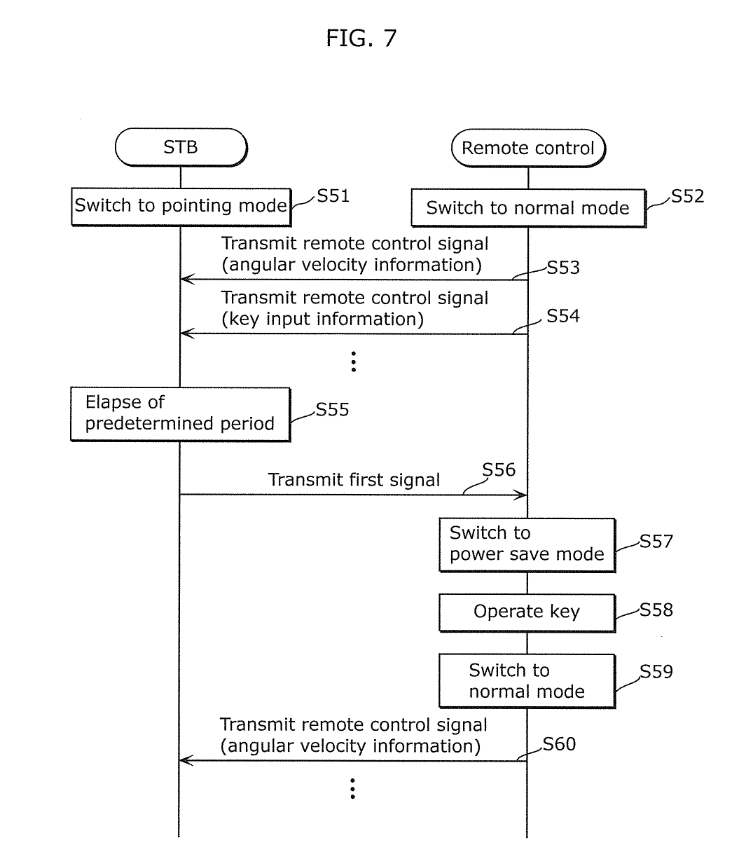

Next, a configuration of the electronic device system according to Embodiment 3 is described with reference to FIG. 7. FIG. 7 is a sequence diagram showing a flow of switching between the normal mode and the power save mode in the electronic device system according to Embodiment 3.

An electronic device system 2 according to this embodiment has a similar functional configuration as an electronic device system according to the above-described Embodiment 1. Thus, a functional configuration of each of a set-top box 4 and a remote control 6 is described with reference to FIG. 1 to FIG. 3.

In the electronic device system 2 according to this embodiment, a timer 34 counts time elapsed from when the set-top box 4 is remotely operated using the remote control 6. Note that, “the set-top box 4 is remotely operated using the remote control 6” means not only the operation of key on the remote control 6 by the user, but also means the remote control 6 is moved in an up-down or right-left direction by the user. This embodiment describes the case in which only the former is meant.

The control unit 36 of the set-top box 4 transmits the first signal to the remote control 6, when determining that the set-top box 4 is not remotely operated using the remote control 6 for a predetermined period (e.g., several seconds to less than twenty seconds) (i.e., a first condition is satisfied for the set-top box 4). The control unit 36 determines, based on the elapsed time counted by the timer 34, that the set-top box 4 is not remotely operated using the remote control 6 for the predetermined period. Note that, “the set-top box 4 is not remotely operated using the remote control 6” means not only the key on the remote control 6 is not operated by the user, but also means the remote control 6 is not moved in an up-down or right-left direction by the user. This embodiment describes the case in which only the former is meant.

In the case where the remote control 6 is operated after receiving the first signal from the set-top box 4, a control unit 50 of the remote control 6 switches a power supply unit 44 from the power save mode to the normal mode. Note that, “the remote control 6 is operated” means not only the operation of the key on the remote control 6 by the user, but also means the remote control 6 is moved in an up-down or right-left direction by the user. This embodiment describes the case in which only the former is meant.

Next, a flow of switching between the normal mode and the power save mode in the electronic device system 2 according to this embodiment is described with reference to FIG. 7. As shown in FIG. 7, the set-top box 4 is switched to the pointing mode by the user pressing a mode switch key 18 on the remote control 6 (S51). Furthermore, the power supply unit 44 of the remote control 6 is switched to the normal mode (S52).

In this state, the user moves the remote control 6 held in a hand in an up-down or right-left direction. With this, the remote control 6 transmits the remote control signal (angular velocity information) to the set-top box 4 (S53). Then, with the operation of the key on the remote control 6 by the user, the remote control 6 transmits the remote control signal (key input information) to the set-top box 4 (S54).

Then, when the set-top box 4 is not remotely operated using the remote control 6 for a predetermined period (e.g., 20 seconds) (S55), the set-top box 4 transmits the first signal to the remote control 6 (S56). The power supply unit 44 of the remote control 6 is switched from the normal mode to the power save mode according to the first signal from the set-top box 4 (S57). With this, supply of power from the power supply unit 44 to the gyro sensor 42 is stopped.

Then, when the user operates a key on the remote control 6 (S58), the power supply unit 44 of the remote control 6 is switched from the power save mode to the normal mode again (S59). With this, the supply of power from the power supply unit 44 to the gyro sensor 42 is resumed.

Note that, the remote control 6 does not transmit the remote control signal (the key input information) to the set-top box 4 in the above-described step S58. Furthermore, in the above-described step S58, the remote control 6 transmits, to the set-top box 4, a signal which indicates that the supply of power to the gyro sensor 42 is resumed.

Thereafter, the gyro sensor 42 measures the angular velocity of the remote control 6 again. Thus, the remote control 6 transmits the remote control signal (the angular velocity information) to the set-top box 4, when the user moves the remote control 6 held in a hand in an up-down or right-left direction (S60).

Next, advantageous effects produced by the electronic device system 2 according to this embodiment are described. As described above, when the user does not operate a key on the remote control 6 for the predetermined period, it is assumed that the user does not need to operate the set-top box 4 and thus does not operate the remote control 6. Thus, with the set-top box 4 transmitting the first signal to the remote control 6 at this point, it is possible to reduce the power supplied from the power supply unit 44 to the gyro sensor 42 in a period in which the user does not operate the remote control 6. This makes it possible to effectively reduce the amount of power consumed by the power supply unit 44 of the remote control 6.

### Embodiment 4

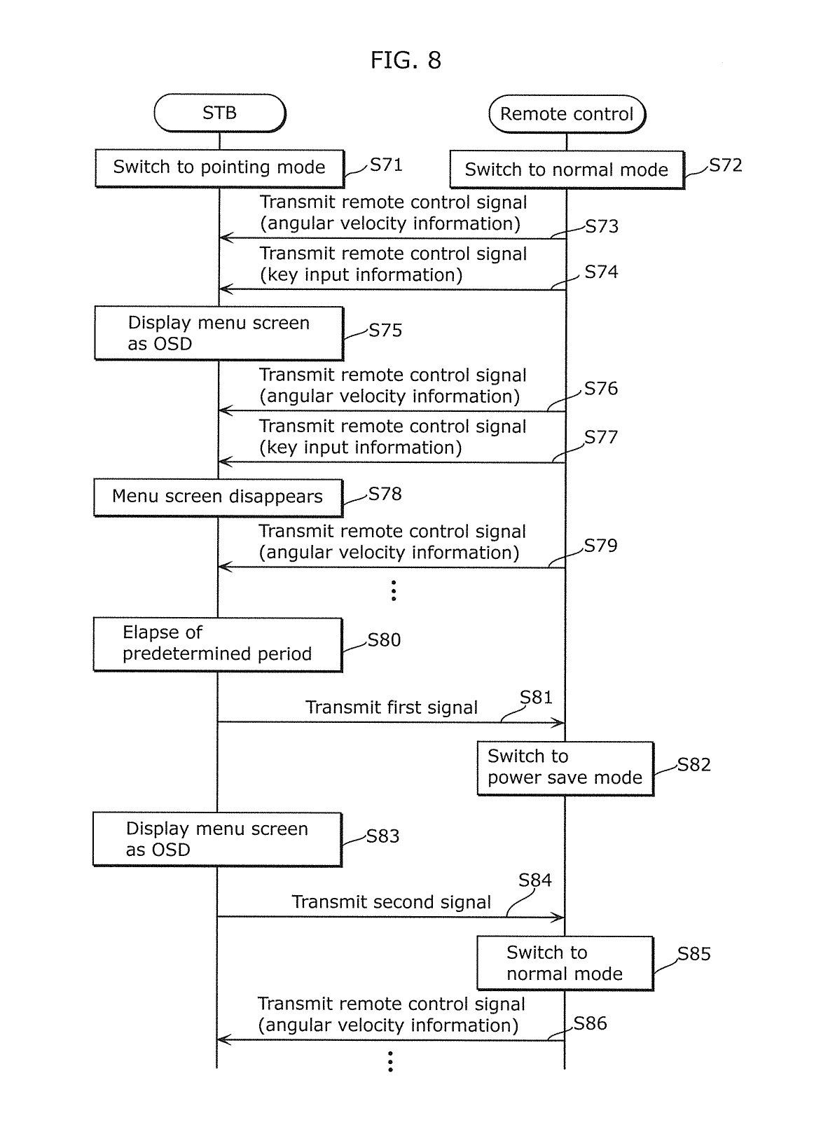

Next, a configuration of an electronic device system according to Embodiment 4 is described with reference to FIG. 8. FIG. 8 is a sequence diagram showing a flow of switching between a normal mode and a power save mode in the electronic device system according to Embodiment 4.

An electronic device system 2 according to this embodiment has a similar functional configuration as an electronic device system according to Embodiment 1 described above. Thus, a functional configuration of each of a set-top box 4 and a remote control 6 is described with reference to FIG. 1 to FIG. 3.

In the electronic device system 2 according to this embodiment, a timer 34 counts a time elapsed from when a menu screen displayed as an OSD on a display panel 12 disappears.

A control unit 36 of the set-top box 4 transmits a first signal to the remote control 6, when determining that the menu screen is not displayed as the OSD on the display panel 12 for a predetermined period (e.g., a few tens of seconds to several minutes) (i.e., a first condition is satisfied for the set-top box 4). The control unit 36 determines, based on the elapsed time counted by the timer 34, that the menu screen is not displayed as the OSD on the display panel 12 for the predetermined period. The control unit 36 further transmits the second signal to the remote control 6, when determining that the menu screen is displayed as the OSD on the display panel 12 after transmitting the first signal to the remote control 6 (i.e., a second condition is satisfied for the set-top box 4).

Note that, the menu screen is, for example, a menu screen of an application for reproducing content, a menu screen of an application including a scheduler function, a menu screen for changing a setting of the set-top box 4, or the like. Alternatively, the menu screen is, for example, a pop-up screen or the like which is displayed when an application including a message communication function receives a message.

Next, a flow of switching between the normal mode and the power save mode in the electronic device system 2 according to this embodiment is described with reference to FIG. 8. As shown in FIG. 8, the set-top box 4 is switched to the pointing mode by a user pressing a mode switch key 18 on the remote control 6 (S71). Furthermore, a power supply unit 44 of the remote control 6 is switched to the normal mode (S72).

In this state, the user places a pointer 20 on an icon 22 (see FIG. 1) on the display panel 12 by moving the remote control 6 held in a hand in an up-down or right-left direction. At this time, the remote control 6 transmits the remote control signal (angular velocity information) to the set-top box 4 (S73). After this, the user presses a determination key 16 on the remote control 6. With this, the remote control 6 transmits the remote control signal (key input information) to the set-top box 4 (S74), activating an application. When the application is activated, a menu screen 52 (see FIG. 5) of the application is displayed as the OSD on the display panel 12 (S75).

After this, the application is terminated with the operation of the remote control 6 by the user (S76, S77), and the menu screen 52 of the application on the display panel 12 disappears (S78). In this state, when the user moves the remote control 6 held in a hand in an up-down or right-left direction, the remote control 6 transmits the remote control signal (the angular velocity information) to the set-top box 4 (S79), and a display position of the pointer 20 moves.

After this, when the menu screen is not displayed as the OSD on the display panel 12 for a predetermined period (e.g., a few tens of seconds to several minutes) (S80), the set-top box 4 transmits the first signal to the remote control 6 (S81). The power supply unit 44 of the remote control 6 is switched from the normal mode to the power save mode according to the first signal from the set-top box 4 (S82). With this, supply of power from the power supply unit 44 to a gyro sensor 42 is stopped.

After this, for example, when a menu screen (not illustrated) of the application including the scheduler function is displayed as the OSD on the display panel 12 (S83), the set-top box 4 transmits the second signal to the remote control 6 (S84). The power supply unit 44 of the remote control 6 is switched from the power save mode to the normal mode again according to the second signal from the set-top box 4 (S85). With this, the supply of power from the power supply unit 44 to the gyro sensor 42 is resumed. Thereafter, the gyro sensor 42 measures the angular velocity of the remote control 6 again. Thus, the remote control 6 transmits the remote control signal (the angular velocity information) to the set-top box 4, when the user moves the remote control 6 held in a hand in an up-down or right-left direction (S86).

Next, advantageous effects produced by the electronic device system 2 according to this embodiment are described. As described above, when the menu screen is not displayed as the OSD on the display panel 12 for a predetermined period, it is assumed that the user does not need to operate the set-top box 4 and thus does not operate the remote control 6. Thus, with the set-top box 4 transmitting the first signal to the remote control 6 at this point, it is possible to reduce the power supplied from the power supply unit 44 to the gyro sensor 42 in a period in which the user does not operate the remote control 6. This makes it possible to effectively reduce the amount of power consumed by the power supply unit 44 of the remote control 6.

Furthermore, when the menu screen is displayed as the OSD on the display panel 12 again, the user is assumed to operate the remote control 6 again. Thus, with the set-top box 4 transmitting the second signal to the remote control 6 at this point, the user can smoothly resume the operation of the remote control 6.

Although the electronic device systems according to Embodiments 1 to 4 of the present invention have been described thus far, the present invention is not limited to these embodiments. For example, the above embodiments may be combined.

The electronic devices include set-top boxes in the above-described embodiments but are not limited thereto. For example, the electronic device may include a television receiver including a Blu-ray (Blu-ray is a registered trademark) drive, a main body of a game machine connected to a television receiver, or the like.

The sensors include gyro sensors in the above-described embodiments but are not limited thereto. For example, the sensor may include an acceleration sensor which measures a rate of acceleration of the remote control as the motion of the remote control.

Note that, the following describes specific examples of communication with which the set-top box turns on and off a gyro sensor of the remote control in the case where the set-top box and the remote control perform bidirectional communication using Bluetooth (Bluetooth is a registered trademark).

As a first example, it is assumed that the remote control is a device which supports the Human Interface Device (HID) Profile. A device which supports the HID Profile has a report descriptor defined in an HID Class of the USB standard. The status of a gyro sensor is defined as an item in advance in the report descriptor. This makes it possible for the set-top box to turn on and off the gyro sensor of the remote control by using GET_REPORT/SET_REPORT Message defined in the Bluetooth (Bluetooth is a registered trademark) HID Protocol Message.

As a second example, it is assumed that the remote control is a device which supports the HID Profile. A device which supports the HID Profile supports the HID_CONTROL request, and the Control Operation value described in last four bits of the request message is reserved from 6 to 15. The set-top box can turn on and off the gyro sensor of the remote control by using a reserved value as a vendor eigenvalue.

As a third example, it is assumed that the remote control is a Bluetooth (Bluetooth is a registered trademark) device which supports some sort of a Profile. The HCI command defined in the Bluetooth (Bluetooth is a registered trademark) Core Specification is used. When using the HCI command, the OpCode which is not defined in the Specification is defined as the vendor specific command. This makes it possible for the set-top box to turn on and off the gyro sensor of the remote control.

As a fourth example, it is assumed that the remote control is a Bluetooth (Bluetooth is a registered trademark) device which supports some sort of a Profile. The set-top box can turn on and off the gyro sensor of the remote control by using the Data field of Request(0x08)/Echo Response(0x09) defined in the Bluetooth (Bluetooth is a registered trademark) Core Specification.

Furthermore, each of the above devices may be configured as, specifically, a computer system that includes a microprocessor, a read only memory (ROM), a random access memory (RAM), a hard disk drive, a display unit, a keyboard, a mouse, and the like. A computer program is stored in the RAM or the hard disk drive. Functions of each of the devices can be achieved by the microprocessor operating in accordance with the computer program. The computer program mentioned here is a combination of a plurality of instruction codes that represent instructions to a computer for achieving a predetermined function.

Furthermore, the structural elements included in each of the above devices may be partly or wholly realized by one system LSI (Large Scale Integration). The system LSI is an ultra-multifunctional LSI produced by integrating a plurality of structural elements on one chip, and is specifically a computer system that includes a microprocessor, a ROM, a RAM, and the like. A computer program is stored in the RAM. Functions of the system LSI can be achieved by the microprocessor operating in accordance with the computer program.

Moreover, the structural elements included in each of the above devices may be partly or wholly realized by an IC card or a single module that is removably connectable to the devices. The IC card or the module is a computer system that includes a microprocessor, a ROM, a RAM, and the like. The IC card or the module may include the above-mentioned ultra-multifunctional LSI. Functions of the IC card or the module can be achieved by the microprocessor operating in accordance with the computer program. The IC card or the module may be tamper resistant.

Furthermore, the present invention may be methods described above. The present invention may be a computer program that realizes the methods by a computer. The present invention may be a digital signal including the computer program.

Furthermore, the present invention may be a non-transitory computer-readable recording medium, such as a flexible disk, a hard disk, a CD-ROM, an MO, a DVD, a DVD-ROM, a DVD-RAM, a Blu-ray (Blu-ray is a registered trademark) Disc (BD), a semiconductor memory, or the like on which the above-described computer program or the above-described digital signal is recorded. Furthermore, the present invention may be the above-described digital signal recorded on such a non-transitory recording medium.

Furthermore, the present invention may be realized by sending the above-described computer program or the above-described digital signal, for example, via an electric communication line, a wireless or wired line, a network typified by the Internet, data broadcasting, or the like.

Furthermore, the present invention may be implemented as a computer system including a microprocessor and a memory. In this case, the memory may store the above-described computer program and the microprocessor may operate according to the above-described computer program.

Furthermore, the above-described program or the above-described digital signal may be executed by another independent computer system, with the above-described program or the above-described digital signal recorded and transported on the above-described non-transitory recording media or the above-described program or the above-described digital signal transported via the above-described network, or the like.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

An electronic device system according to the present invention can be applied to, for example, an electronic device system or the like in which a set-top box connected to a television receiver is remotely operated using a remote control.

1. An electronic device system comprising:
an electronic device which causes a display unit to display an image; and
a remote control which is capable of bidirectionally communicating with the electronic device, for remotely operating the electronic device,
wherein the remote control includes:
a sensor which detects a motion of the remote control;
a power supply unit switchable between (i) a normal mode in which power is supplied to the sensor and (ii) a power save mode in which power supply to the sensor is stopped; and
a communication unit configured to transmit, based on the motion of the remote control detected by the sensor, a remote control signal for remotely operating the electronic device,
the electronic device transmits a first signal to the remote control, when determining that a first condition is satisfied for the electronic device, and
the power supply unit of the remote control is switched from the normal mode to the power save mode, according to the first signal from the electronic device.

2. The electronic device system according to claim 1,
wherein the electronic device further transmits a second signal to the remote control, when determining that a second condition is satisfied for the electronic device after transmitting the first signal to the remote control, and
the power supply unit of the remote control is switched from the power save mode to the normal mode, according to the second signal from the electronic device.

3. The electronic device system according to claim 2,
wherein the electronic device includes an application which is for reproducing content, and
the electronic device determines that the first condition is satisfied for the electronic device, when an operation of the remote control for changing a reproduction state of the content is not performed for a predetermined period while the application reproduces the content.

4. The electronic device system according to claim 3,
wherein the electronic device determines that the second condition is satisfied for the electronic device, when the application ends reproduction of the content after the electronic device transmits the first signal to the remote control.

5. The electronic device system according to claim 2,
wherein the electronic device is connectable with an operation device which is for operating the electronic device, and
the electronic device determines that the first condition is satisfied for the electronic device, when the operation device is connected to the electronic device.

6. The electronic device system according to claim 5,
wherein the electronic device determines that the second condition is satisfied for the electronic device, when the operation device and the electronic device are disconnected after the electronic device transmits the first signal to the remote control.

7. The electronic device system according to claim 1,
wherein the electronic device determines that the first condition is satisfied for the electronic device, when the electronic device is not remotely operated using the remote control for a predetermined period.

8. The electronic device system according to claim 7,
wherein the power supply unit of the remote control is switched from the power save mode to the normal mode, when the remote control is operated after the remote control receives the first signal from the electronic device.

9. The electronic device system according to claim 2,
wherein the electronic device determines that the first condition is satisfied for the electronic device, when a menu screen is not displayed as an on-screen display (OSD) on the display unit for a predetermined period.

10. The electronic device system according to claim 9,
wherein the electronic device determines that the second condition is satisfied for the electronic device, when the menu screen is displayed as the OSD on the display unit after the electronic device transmits the first signal to the remote control.

11. The electronic device system according to claim 1,
wherein the sensor is a gyro sensor or an acceleration sensor.

12. The electronic device system according to claim 1,
wherein the display unit is provided on a television receiver, and
the electronic device is a set-top box connected to the television receiver.
